(19) United States
(12) Patent Application Publication
(10) Pub. No.: US 2025/0015984 A1
(43) Pub. Date: Jan. 9, 2025

(54) Use Of Quantum Resistant Iterative Keypads For Large Files

(71) Applicant: Theon Technology LLC, Newport Beach, CA (US)

(72) Inventors: Robert Edward Grant, Laguna Beach, CA (US); Eric Olsen, Lake Forest, CA (US)

(21) Appl. No.: 18/218,283

(22) Filed: Jul. 5, 2023

(51) Int. Cl. H04L 9/08; H04L 9/32

(52) U.S. Cl. CPC H04L 9/0869; H04L 9/3242

(57) ABSTRACT

A method for generating large quantum-resistant encryption keys for the generation of a cyphertext from a plaintext file. The system generates two large keys in a parallel process using initial seed values to provide quantum-resistant output values that are used to generate the cyphertext. The size of the output keys are dictated by the size of the input keys and are not limited to the sizes of standardized encryption schemes.

### FIELD OF THE INVENTION

The field of the invention is data and information security technologies.

### BACKGROUND

The background description includes information that may be useful in understanding the present invention. It is not an admission that any of the information provided herein is prior art or relevant to the presently claimed invention, or that any publication specifically or implicitly referenced is prior art.

Data security has been a concern for as long as computers have existed. The constant cat-and-mouse game between those protecting their data and those wishing to obtain it nefariously is always evolving. Current cryptographic methods have provided adequate security for most uses, but the advent of quantum computing threatens to challenge the status quo once again.

In response to this looming shift, others have attempted to anticipate and ameliorate the risks to prior systems. One such approach is describe in the paper titled “Safely Doubling your Block Ciphers for a Post-Quantum World”, published by Bhaumik, et al on Oct. 7, 2022 (hereinafter “Bhaumik”). This paper describes an approach for providing greater quantum security that the authors call QUEME, and is incorporated herein by reference in its entirety.

While QuEME improves upon prior security approaches, it is not perfect. QuEME does what it was designed to do. However, it can only handle 256 bits at a time (two inputs of 128 bits at a time). Therefore, to encrypt a large data file, the QuEME process has to be repeated 256 bits at a time.

Another problem with the existing solutions is QuEME approaches the quantum resistance by doubling the key size, which currently is acceptable but unlikely to be future-proof.

Thus, there is still a need for quantum-resistant data security technique that can adequately protect data while remaining as computationally inexpensive as possible.

### SUMMARY OF THE INVENTION

The inventive subject matter provides apparatus, systems and methods in which a computing device can generate quantum-resistant keys for large data files.

The computing device obtains two seed numbers (first and second seeds) and two encryption keys, and encrypts each of the seed numbers with a corresponding encryption key. The computing device then executes an XOR operation on the first and second outputs of the encryption and applies a collapsing function to the XOR output to generate a new key that is used to encrypt the encrypted output of the first seed number with the first key. The output of the XOR function and the newly-encrypted value are XORed to generate a new XOR output. This new XOR output and the twice-encrypted value are each encrypted with encryption keys to generate output values. These output values are used to transform a plaintext into a cyphertext via methods such as an XOR function.

In most embodiments, the plaintext data is considered to be significantly larger than the output values. For example, for a 10 KB file, the process can be run five times because the output for two 1 KB seed inputs is 2 KB (two 1 KB outputs). The outputs are concatenated and used to transform the plaintext into a cyphertext.

The input values and output values, as well as the transitional values (the encrypted values, outputs of the XOR functions), are all larger than the keys used. For example, the input seed values and the output values can be 1 KB and the keys 128 bits.

In embodiments of the inventive subject matter, the keys can be encryption keys according to a known encryption scheme, such as AES.

In embodiments of the inventive subject matter, the collapsing function can be a hash function that generates 128 bits of output or other output sizes. For example, a SHA-1 (generating 160 bits of output), SHA-2 or a SHA-3 function (both generating 256 bits of output) can be used. In embodiments where a SHA-2 or SHA-3 function is used, 128 bits of the 256-bit output can be used for the encryption at that stage and the remaining 128 bits can be used for another encryption later in the process.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a.” “an.” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is an overview of the prior art QUEME process.

FIG. 2 is a diagrammatic overview of the processes executed according to embodiments of the inventive subject matter.

FIG. 3 is a flowchart that illustrates the process of FIG. 2.

### DETAILED DESCRIPTION

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including the ability to generate quantum-resistant encrypted data rapidly and efficiently.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

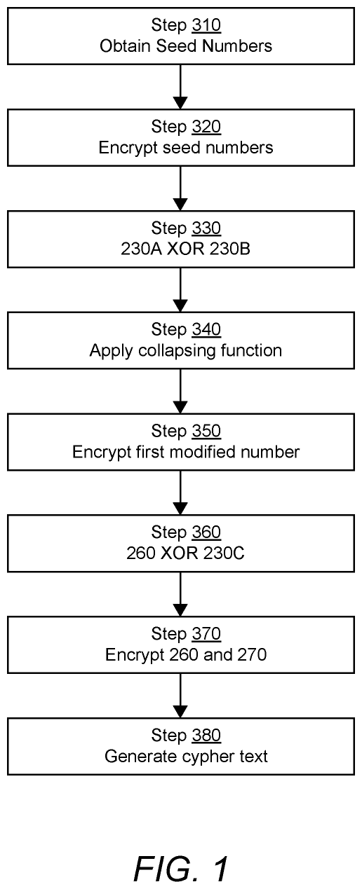

FIG. 1 is a diagrammatic overview of the known QUEME sequence as described in Bhaumik. It is understood that the QuEME process described in Bhaumik results in encryption keys that are twice as large as normal keys. The QuEME process enhances security, but does not provide a future-proof solution because what may not be practical or even possible for current computer devices may be easy for future devices. In the QuEME process, the inputs are two 128-bit numbers that result in two 128-bit keys. This means that for a large data set, the process must be run over and over again to generate a sufficiently large data set to perform an XOR operation of a plaintext file. While the QuEME process provides improvements over traditional encryption schemes, it still has limitations that are addressed by the systems and methods of the inventive subject matter.

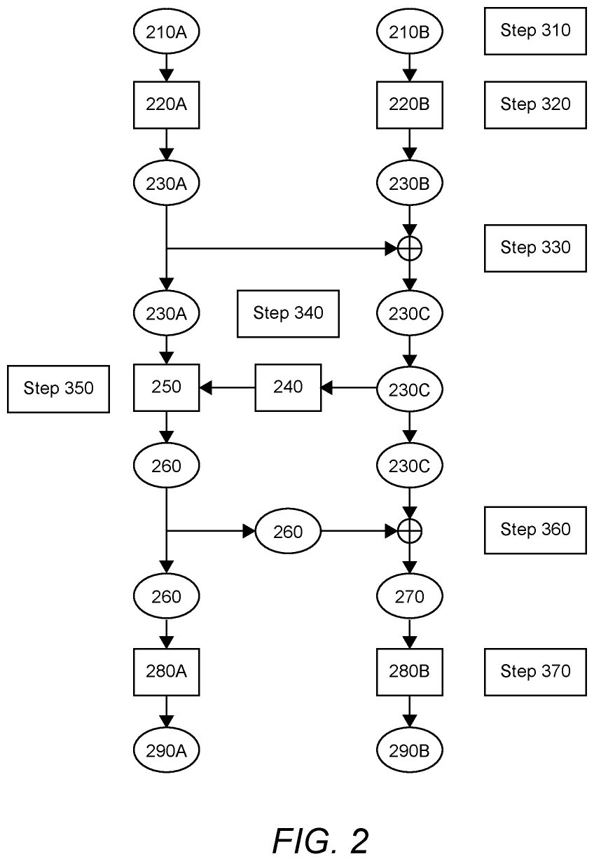

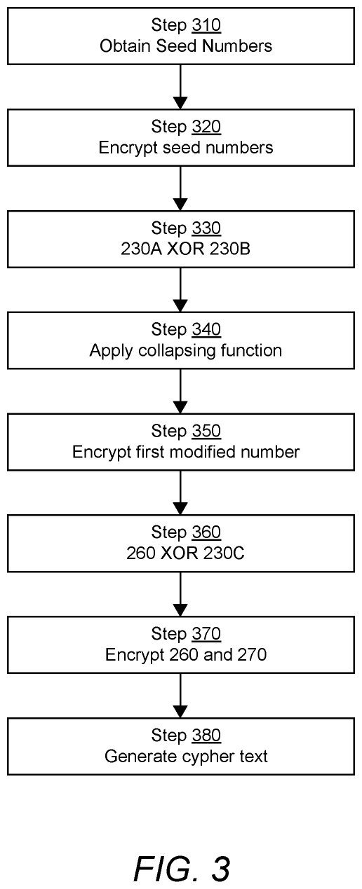

FIG. 2 is a diagrammatic overview of the processes executed according to embodiments of the inventive subject matter. FIG. 3 is a description of these processes in flowchart form.

The processes herein are described as being performed by “a computing device” or “a computing system”. A computing device or a computing system is understood to be one or more computer hardware devices that include at least one processor, at least one non-transitory memory (e.g., ROM, RAM, hard drive, solid state drive, etc.) that stores the data and executable instructions that cause the one or more processors to execute the processes discussed herein, and one or more communication interfaces that enable the computing device to exchange data with other computing devices and/or databases. The computing device/systems can also include input/output interfaces that allow a user to input data into and receive data from the device (e.g., mouse and keyboard, touchscreen, speakers, monitors, stylus, etc.). Examples of suitable computing devices can include servers, desktop computers, laptop computers, tablets, smartphones, gaming consoles, etc. It is understood that the processes discussed here can be performed by a single device and/or distributed among several computing devices.

At step 310, a computing device obtains a first seed number 210A and a second seed number 210B.

The computing device performing the processes discussed herein can also perform the function of generating the seed numbers 210A, 210B. Thus, in these embodiments, the step of obtaining a first seed number 210A and a second seed number 210B comprises generating the seed numbers.

In other embodiments, a different computing device or computer system can be responsible for generating the seed numbers 210A, 210B. In these embodiments, the computing device performing the process obtains the seed numbers 210A, 210B from the generating device at step 310.

In embodiments of the inventive subject matter, the first seed number 210A and second seed number 210B can be generated based on a counter, such that seed numbers can be sequentially generated as needed.

In embodiments of the inventive subject matter, the first and second seed numbers 210A. 210B can be in the form of a media file (or two media files, one for each seed number 210A, 210B). For example, the media file can be an image file, where the seed numbers can be displayed within the image. Alternatively, the seed numbers 210A, 210B can be the numbers of the code making up the media file. Other types of media files can include audio files (e.g., sounds, music, etc.), video files, etc.

In embodiments of the inventive subject matter, the first and second seed numbers 210A, 210B can public information or information that is otherwise not concealed or kept secret. Thus, the first and second seed numbers 210A, 210B can be transmitted from one computing device to another through regular communication channels which can be encrypted or unencrypted (e.g., email, text, streaming, video, audio, fax, cellular signal, Wifi, wired, etc.).

In embodiments of the inventive subject matter, the first seed number 210A and second seed number 210B can be generated by a random number generator.

At step 320, the computing device modifies the first seed number 210A with a first key 220A to result in a first modified number 230A and modifies the second seed number 210B with a second key 220B to result in a second modified number 230B.

In the illustrated example contained here, the first and second keys 220A, 220B are encryption keys and the modification of step 320 is an encryption. Thus, at step 320 the computing device encrypts the first seed number 210A with the first encryption key 220A to result in a first modified number 230A and encrypts the second seed number 210B with a second encryption key 220B to result in a second modified number 230B.

The first seed number 210A and second seed number 210B are preferably larger than the keys 220A, 220B. In the embodiment illustrated herein, for example, the first seed number 210A and the second seed number 210B are each 1 KB in size, whereas the first and second keys 220A, 220B are 128-bit keys. In this example, the resulting first modified number 230A and second modified number 230B are also 1 KB in size.

In embodiments such as the ones discussed herein, the first and second keys 220A, 220B are keys according to an encryption scheme. For example, in the illustrated example, the first and second keys 220A, 220B are Advanced Encryption Standard (“AES”) encryption keys of 128-bit. AES encryption keys of other sizes are contemplated as well, as are keys generated and used according to a different encryption scheme.

In embodiments, the first and second keys 220A, 220B are obtained from a cryptographically secure random number generator such that the keys are not practically predictable.

At step 330, the computing device executes an XOR function with the first modified number 230A and the second modified number 230B as inputs, to result in a first XOR number 230C. The first XOR number 230C is the same size as the first modified number 230A and the second modified number 230B. In this example, thus, the first XOR number 230C is 1 KB.

At step 340, the computing device applies a collapsing function to the first XOR number 230C to result in a new key 250.

In embodiments of the inventive subject matter such as the one illustrated here, the collapsing function is a hash function. As such the computing device hashes the first XOR number 230C to result in the new key 250.

In embodiments of the inventive subject matter, the hash function is a Secure Hash Algorithm (“SHA”) standard hash function. In some variations of the inventive subject matter, the hash function is a SHA algorithm that results in at least a 128-bit new key 250.

In embodiments of the inventive subject matter such as the one discussed herein, the hash function is a SHA-256 algorithm (such as SHA-2 or SHA-3) that outputs a 256-bit value. The computing device then takes 128 bits from the 256-bit value as the new key 250 and can use the remaining 128 bits from the 256-bit value discussed in additional detail below.

In embodiments of the inventive subject matter, the collapsing function can be a function other than a hash function. For example, the collapsing function can be an XOR function where only 128 bits are then taken to be used at step 350 below. In another example, the collapsing function is a polynomial that uses the bits of the input stream (the first XOR number 230C) to reduce the output to 128 bits.

At step 350, the computing device encrypts the first modified number 230A with the new key 250 to obtain a third modified number 260. The third modified number 260 is of the same length/size as the first modified number 230A. In this example, the third modified number is 1 KB.

At step 360, the computing device executes an XOR operation using the third modified number 260 and the first XOR number 230C to result in a second XOR number 270. The second XOR number 270 is the same size/length as the third modified number 260 and the first XOR number 230C. In the illustrative example discussed herein, the second XOR number 270 is 1 KB.

At step 370, the computing device modifies the third modified number 260 with a third key 280A to result in a first output value 290A and modifies the second XOR number 270 with a fourth key 280B to result in a second output number 290B.

In the illustrated example contained here, the third and fourth keys 280A, 280B are encryption keys and the modification of step 370 is an encryption. Thus, at step 370 the computing device encrypts the third modified number 260 with the third key 280A to result in a first output value 290A and encrypts the second XOR number 270 with a fourth key 280B to result in a second output number 290B.

In embodiments such as the ones discussed herein, the third and fourth keys 280A, 280B are keys according to an encryption scheme. For example, in the illustrated example, the third and fourth keys 280A, 280B are 128-bit AES encryption keys. AES encryption keys of other sizes are contemplated as well, as are keys generated and used according to a different encryption scheme.

In embodiments of the inventive subject matter, the third key 280A is derived from the first key 220A and the fourth key 280B is derived from the second key 220B. For example, the third key 280A can be a shifted version of first key 220A and the fourth key 280B can be a shifted version of the second key 220B (e.g., the values of first key 220A and second key 220B are shifted by a certain amount to produce the third key 280A and fourth key 280B, respectively). In the embodiments discussed herein, the third and fourth keys 280A, 280B are AES keys. They are considered to be 128-bit keys.

In some embodiments, the third key 280A is the output of an XOR function that uses the first key 220A and the second 220B as the inputs to the function. Thus, third key 280A is first key 220A XOR second key 220B. In these embodiments, the fourth key 280B can be the value of the first key 220A XOR second key 220B plus a shift.

In embodiments of the inventive subject matter where the third and fourth keys 280A, 280B are derived at least in part from the first and second keys 220A, 220B and do not depend on information or data from further on in the process, the third and fourth keys 280A, 280B can be derived in a parallel process to the process discussed herein, sometime after the first and second keys 220A, 220B are created or obtained. This way, the third and fourth keys 280A, 280B will have been generated before the process arrives at step 370, reducing a potential performance bottleneck.

Each of the first output value 290A and second output value 290B is the same size as the third modified number 260 and the second XOR number 270, respectively. As will be appreciated by the astute reader, this also means that the first output value 290A and the second output value 290B are the same size as the first and second seed values 210A, 210B that are used as the inputs to the process. In this example, the first output value 290A and the second output value 290B are 1 KB each.

The astute reader will appreciate that the outputs that are to be used to generate a cyphertext (also could be considered a stream cypher) are quantum resistant.

At step 380, the computing device utilizes the first output value 270A and second output value 270B to generate a cyphertext of a plaintext file. The plaintext file can be significantly larger than the first output value 270A and the second output value 270B.

In order to use the first and second output values 290A, 290B to generate the cyphertext, the computing device first concatenates the first and second output values 290A, 290B to generate a concatenated output value that is the combined size of the two output values 290A, 290B. In this case, where the two output values 290A, 290B are each 1 KB, the concatenated output value is 2 KB.

Where the plaintext file is larger than the concatenated output value, the processes discussed herein are executed multiple times until a plurality of concatenated output values are obtained that equal the length of the plaintext file. For example, if a plaintext file is 10 KB and the concatenated output value is 2 KB then the processes discussed above will be repeated five times to generate five 2 KB outputs that equal the 10 KB plaintext file size.

The generation of the cyphertext from the plaintext can be an XOR operation of the plaintext file XOR the combined concatenated output value(s) to result in the cyphertext.

In embodiments of the inventive subject matter, the plaintext can be divided up into sections that equal the concatenated output size. Thus, a 10 KB plaintext can be divided into 2 KB sections that are then converted to cyphertext by applying the 2 KB concatenated output. Then the process is executed to generate additional 2 KB concatenated output files.

In embodiments of the inventive subject matter where a SHA-256 function is used, the “remaining” 128 bits from step 340 can be used as a key to encrypt the concatenated output value prior to the generation of the cyphertext, adding another layer of security.

In other embodiments of the inventive subject matter, the remaining 128 bits can be used as one of the keys 220A, 220B in the subsequent “round” of executing of the process.

In still other embodiments of the inventive subject matter, the remaining 128 bits can be used as an additional encryption layer to the cyphertext.

In still other embodiments of the inventive subject matter, the remaining 128 bits can be used to alter the counter values used as the input seed numbers 210A, 210B for subsequent executions of the process.

It is appreciated that the systems and methods of the inventive subject matter discussed herein allow for the use of public or otherwise non-secret seed values. Knowing the seed values ahead of time would not enable an intruder to derive the rest of the processes or the outputs used to generate the cypher text. However, in embodiments where true random numbers could be generated as seeds, the initial steps 310, 320 could be removed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for generating quantum-resistant keys, comprising:
obtaining, by a computing device, a first key and a second key;
obtaining, by the computing device, a first seed number and a second seed number, wherein each of the first and second seed numbers have a larger amount of digits than the first key and second key;
applying, by the computing device, the first key to the first seed number to generate a first modified number and the second key to the second seed number to generate a second modified number;
performing, by the computing device, an XOR operation using the first modified number and the second modified number to generate a first XOR number;
applying, by the computing device, a collapsing function to the first XOR number to generate a new key;
encrypting, by the computing device, the first modified number with the new key to generate a third modified number;
performing, by the computing device, an XOR operation using the third modified number and the first XOR number to generate a second XOR number;
applying, by the computing device, a third key to the third modified number to generate a first output number and a fourth key to the second XOR number with to generate a second output number; and
generating, by the computing device, a cyphertext of a plaintext data file using the first output number and second output number.

2. The method of claim 1, wherein the first key, second key, third key and fourth key are AES keys.

3. The method of claim 2, wherein the first key, second key, third key and fourth key are 128-bit keys.

4. The method of claim 1, further comprising wherein the step of applying the first key to the first seed number to generate a first modified number and the second key to the second seed number to generate a second modified number comprises encrypting the first seed number with the first key to generate the first modified number and encrypting the second seed number with the second key to generate the second modified number.

5. The method of claim 1, further comprising wherein the step of applying the third key to the third modified number to generate a first output number and the fourth key to the second XOR number to generate a second output number comprises encrypting the third modified number with the third key to generate the first output number and encrypting the second XOR number with the fourth key to generate the second output number.

6. The method of claim 1, wherein the collapsing function comprises a hash function.

7. The method of claim 6, wherein the hash function comprises a SHA hash function.

8. The method of claim 7, wherein the hash function comprises a SHA-256 hash function.

9. The method of claim 8, wherein the output of the hash function outputs a 256-bit number, the method further comprising:
using a 128-bit number from the 256-bit number as the new key; and
using the remaining 128-bit number from the 256-bit number as a key to encrypt a concatenated output comprising the first output number and the second output number.

10. The method of claim 1, wherein the collapsing function comprises an XOR function.

11. The method of claim 1, wherein the collapsing function comprises a polynomial with a 128-bit output.

12. The method of claim 1, wherein the first seed number and second seed number are generated based on a counter.

13. The method of claim 1, wherein the plaintext data file is larger than at least one of the first output number and second output number.

14. The method of claim 1, wherein the third key is generated based on the first key and the fourth key is generated based on the second key.
